(19) United States
(12) Patent Application Publication
(10) Pub. No.: US 2003/0172561 A1
(43) Pub. Date: Sep. 18, 2003

(54) Box merchant's display and associated business method for promoting box sales

(76) Inventor: Chad Miller, San Antonio, TX (US)

Correspondence Address: DAVID G. HENRY, 900 Washington Avenue, P.O. Box 1470, Waco, TX, 76701, US

(21) Appl. No.: 10/099,544

(22) Filed: Mar. 15, 2002

(51) Int. Cl. G09F 3/00

(52) U.S. Cl. 40/312

(57) ABSTRACT

A three-dimensional advertizing display and associated business method use thereof, that, while not actually including real boxes, assumes the appearance of a stylized stack of boxes. The components have indicia printed thereon which advertizing the availability of boxes, as well as any other desired information (dealer's phone number, sizes available, prices, etc.).

### BACKGROUND OF THE INVENTION

1. Field of The Invention

The present invention relates to three dimensional sales aid for merchants.

2. Background Information

Capturing the attention of the consuming public is a never-ending challenge for merchants of all goods and services. The same is true of those who sell boxes for moving, storage, etc.

A mere sign which advertizes the availability of boxes for sale is not likely to attract a great deal of attention. Furthermore, certain merchants of boxes sell a number of products or services, and any given member of the consuming public may or may not be aware of the availability of boxes. Therefore, an “eye-catching” advertisement medium is all the more necessary.

Advertizing media is rather expensive. Ordinarily, the general principle is that the more effective the device, the more expensive it will be. For example, a large sign is more expensive than a small one. A multi-colored sign is more expenses than one with no, or fewer colors. A display with photography is more expensive than one with simple graphics.

Box retailing is not necessarily a high profit margin activity. Therefore, prior to the present invention, advertising media's being other than cost prohibitive, and still highly effective, were mutually exclusive for most retailers.

In view of the above, it would well-serve those who sell boxes, and those who need to purchase boxes (often in the rush of per-move activities, and ill-prepared for time consuming searches for available boxes, to provide a novel advertising media which is both cost effective and highly effective in marketing boxes.

### SUMMARY OF THE INVENTION

It is an object of the present invention to provide an improved advertizing media.

It is another object of the present invention to provide an improved advertizing media for use in marketing boxes.

It is another object of the present invention to provide an improved advertizing media for box retailing, which is both highly cost effective and effective in attracting consumer attention.

It is another object of the present invention to provide an improved advertizing media for box retailing, which mimicks the appearance of the actual product being sold, while presenting an attractive appearance for marketing aesthetics considerations.

It is another object of the present invention to provide an improved advertizing media for use in promoting box sales, which media is easily transported and assembled, and thereby easily disseminated to retailers nationwide.

In satisfaction of these and related objects, the present invention provides a three-dimensional advertizing display and associated business method use thereof, that, while not actually including real boxes, assumes the appearance of a stylized stack of boxes. The components have indicia printed thereon which advertizing the availability of boxes, as well as any other desired information (dealer's phone number, sizes available, prices, etc.).

The three-dimensional display of the present invention is easily compacted into a slim shipping box, and once received by the end-user, easily assembled.

The present display can be fabricated of any number of relatively inexpensive materials, including fiberboard, plastic sheeting, cardboard, etc.

### BRIEF DESCRIPTION OF THE DRAWINGS

FIG. 1 is a perspective view of a three-dimensional box advertizing display of the present invention.

FIG. 2 is an exploded perspective view of the preferred embodiment of the present three-dimensional advertizing media.

### DETAILED DESCRIPTION OF THE PREFERRED EMBODIMENT

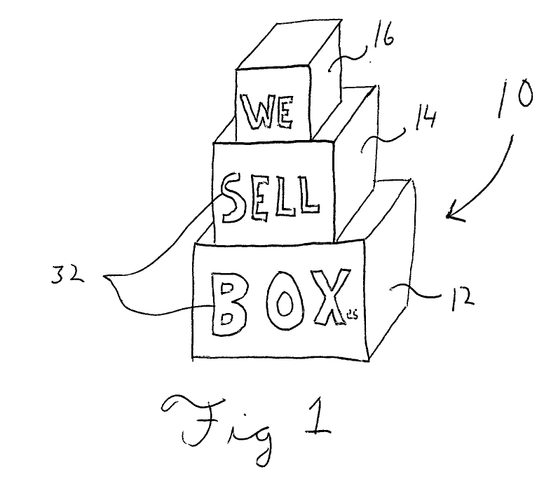

Referring to FIG. 1, the advertizing display of the present invention is identified generally by the reference number 10. Display 10 is, in the preferred embodiment, comprised of three individual modules 12, 14 and 16. However, it should be understood that either two modules, or more than three modules can be used, depending on the desired size and visual impact for the diplay in any given case.

Modules 12, 14 and 16 are designed to interface such that display 10 becomes a single unit. This is important, as the display may be set outdoors, or placed in environments where one or more modules being knocked over, or off the (apparent) stack would be undesirable.

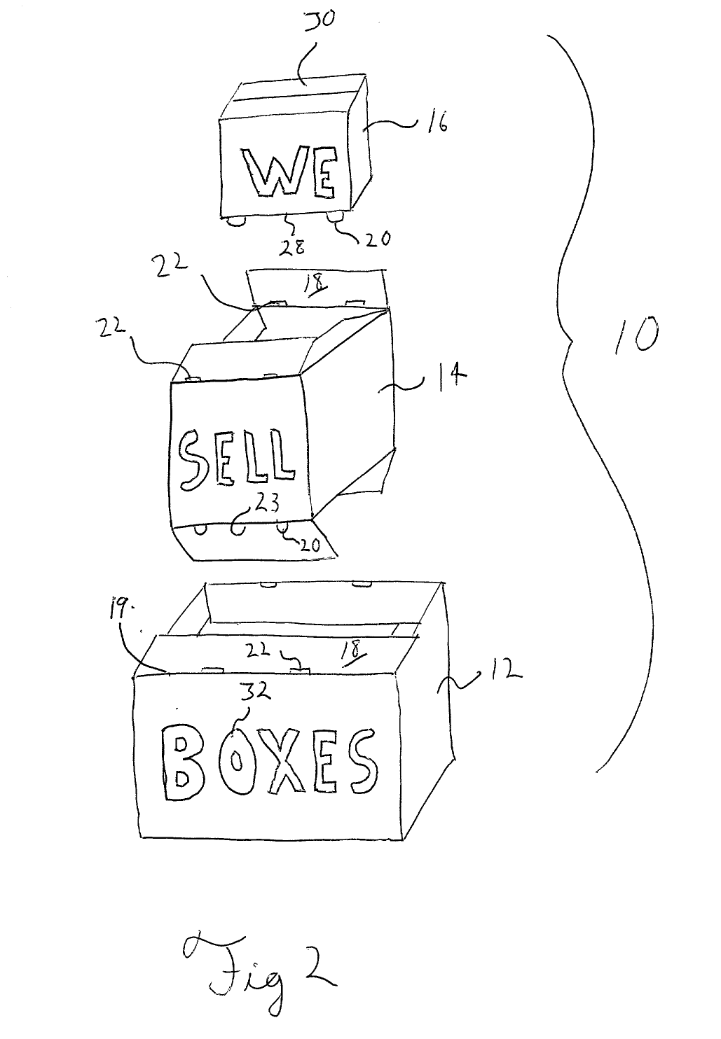

Referring specifically to FIG. 2, mobule 12 is fabricated much like a standard box, and includes box flaps 18. However, interface slots 20 are provided at the upper margin 19 of module 12 and are sized and spaced to receive interface tabs 22 which extend from the lower margin 23 of module 14.

Interface tabs 22 are cut-out of flaps 18 of module 14, such that they extend outward from module 14 when flaps 18 of module 14 are folded in, as when module 14 is incorporated into the over-all display 10.

As in the case of module 12, interface slots 20 are formed at the upper margin 26 of module 16, and are sized and spaced to receive interface tabs 22 which extend from the lower margin 28 of module 16.

The top surface 30 of module 16 is, once flaps 18 are closed as in the case of a conventional box, a solid surface.

It should be noted that interface tabs 22 may be slotted in such a manner as to “lock” themselves inside each corresponding interface slot 20.

Indicia 32 is, in the preferred emdodiment, printed on each face of each module 12, 14, and 16 according to the desires of the end-user.

Through use of embodiments of the present invention, customers' attention is readily gained. Appropriate choices of color, both for the modules 12, 14 and 16 themselves, and for indicia 32 thereon, will greatly enhance the attractiveness and effectiveness of display 10 as an advertising media item.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention. I claim:

1. An improved advertising display for promoting box sales comprising:
a plurality of modules, each said module being a three-dimensional representation of a box, each said module having interface means for securely engaging with an adjacent said module; and
advertising indicia printed on at least one of said modules.

2. A business method for promoting the sales of boxes including the steps of:
selecting an advertising display for promoting box sales comprising:
a plurality of modules, each said module being a three-dimensional representation of a box, each said module having interface means for securely engaging with an adjacent said module; and
advertising indicia printed on at least one of said modules;
causing said indicia to communicate the availability of boxes for sale;
assembling said modules into a three-dimensional display; and
placing the assembled three-dimensional display at a location viewed by actual or potential box consumers.
